(19) United States
(12) Patent Application Publication
(10) Pub. No.: US 2007/0124942 A1
(43) Pub. Date: Jun. 7, 2007

(54) Ball bearing tension system for a shear

(76) Inventors: Stephen M. Nenadich, Redlands, CA (US); Donald L. Shedrow, Charlotte, NC (US)

Correspondence Address: STEVEN N. FOX, ESQ., P.O. BOX 251, CANTON, MA, 02021, US

(21) Appl. No.: 11/296,860

(22) Filed: Dec. 7, 2005

(51) Int. Cl. B26B 13/28

(52) U.S. Cl. 30/266

(57) ABSTRACT

The present invention is a device for cutting hair. In one embodiment, the device comprises a first blade member comprising an inner surface having a ride-on portion, an outer surface having a recessed portion disposed opposite the ride-on portion, and a thru-hole. The device further comprises a second blade member comprising an inner surface having a ride-on portion in contact with the ride-on portion of the first blade member, an outer surface having a recessed portion disposed opposite the ride-on portion, and a thru-hole aligned with the thru-hole of the first blade member. The device further comprises first and second ball bearing units disposed in the recessed portions of the first and second blade members, respectively. Each of the ball bearing units comprise an inner sleeve and an outer sleeve engaged with the recessed portions of the first and second blade members, respectively. The device further comprises a tension screw passing through the inner sleeves of the first and second ball bearing units and the thru-holes of the first and second blade members. The device further comprise a tension knob engaged with the tension screw to maintain engagement of the ride-on portion of the first blade member with the ride-on portion of the second blade member.

### BACKGROUND OF THE INVENTION

Devices such as shears have been used for many years to cut a person's hair. High quality hair cutting shears used by professional hair stylists are expensive. An important part of the shear design lies in the what is referred to as the “pivot area” or “ride-on area.” The ride-on area of one blade is engaged with the ride-on area of the other blade and each must be fabricated to precise dimensions so that the blades do not have any play or wobble movement when open and closed during the cutting of a person's hair. Conventional shears employ a tension system having a tension screw, a tension knob, and a leaf spring in an effort to adjust and maintain contact or engagement of the ride-on areas of each blade. Such conventional designs also employ one or more nylon bushings about which the blades rotate thereby forming an important part of the overall tension system. These nylon bushings become worn and fail after prolonged use rendering the tension system ineffective resulting in unacceptable cutting operations and significant repair costs.

### SUMMARY OF THE INVENTION

One object of the present invention is to provide a hair cutting device such as a shear having a tension system that will not fail over a period of prolonged use.

In one embodiment, the hair cutting device comprises a first blade member comprising an inner surface having a ride-on portion, an outer surface having a recessed portion disposed opposite the ride-on portion, and a thru-hole. The device further comprises a second blade member comprising an inner surface having a ride-on portion in contact with the ride-on portion of the first blade member, an outer surface having a recessed portion disposed opposite the ride-on portion, and a thru-hole aligned with the thru-hole of the first blade member. The device further comprises first and second ball bearing units disposed in the recessed portions of the first and second blade members, respectively. Each of the ball bearing units comprise an inner sleeve and an outer sleeve engaged with the recessed portions of the first and second blade members, respectively. The device further comprises a tension screw passing through the inner sleeves of the first and second ball bearing units and the thru-holes of the first and second blade members. The device further comprise a tension knob engaged with the tension screw to maintain engagement of the ride-on portion of the first blade member with the ride-on portion of the second blade member. Unlike conventional devices, the first and second ball bearing units provide precise consistent engagement of the ride-on portions and pivoting of the first and second blade members over an extended period of use.

### BRIEF DESCRIPTION OF DRAWINGS

The following description of the invention will make reference to the accompanying drawings wherein:

FIG. 1 is a top perspective view of a first embodiment of a hair cutting device in accordance with the present invention;

FIG. 2 is a top exploded view of the hair cutting device;

FIG. 3 is a bottom exploded view of the hair cutting device;

FIG. 4 is a cross-section view taken along line 4-4 of FIG. 1; and

FIG.5 is a perspective view of the ball bearing unit;

FIG. 6 is a perspective view of the leaf spring;

FIG. 7 is a perspective view of the bushing; and

FIG. 8 is a top exploded view of a second embodiment of a hair cutting device according to the present invention.

### DESCRIPTION OF THE INVENTION

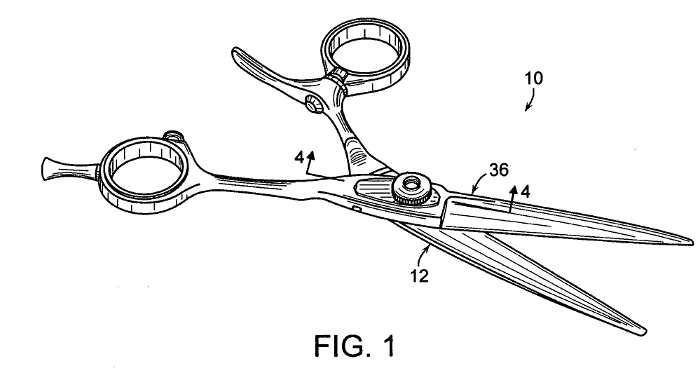

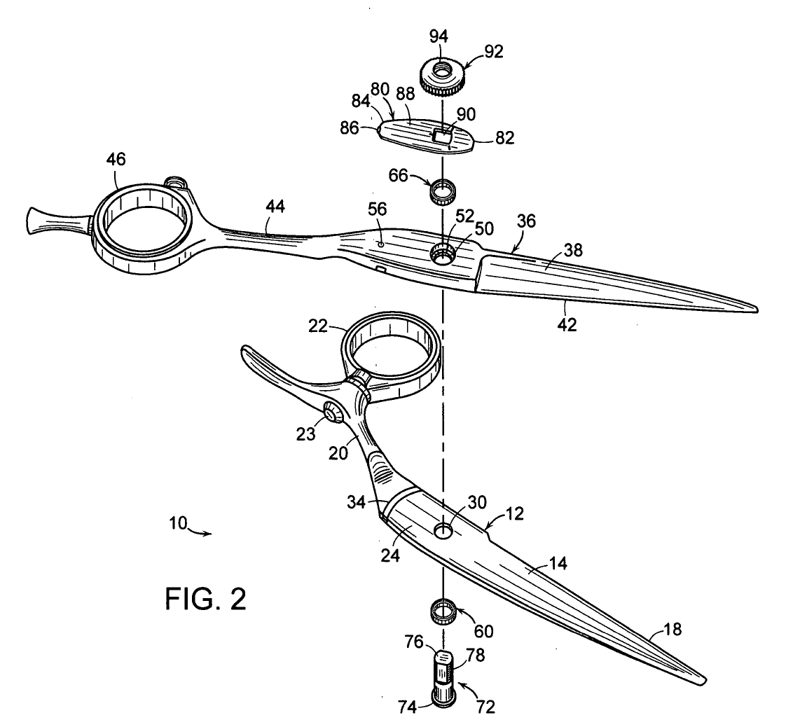

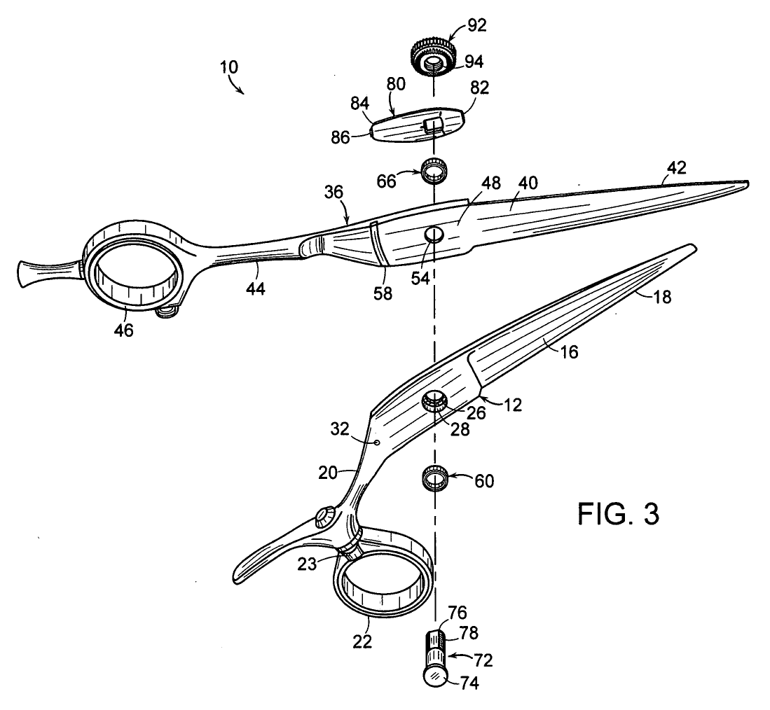

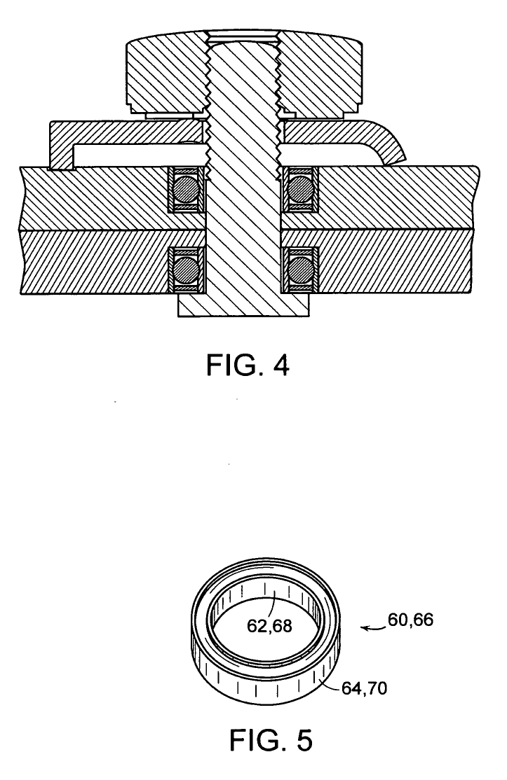

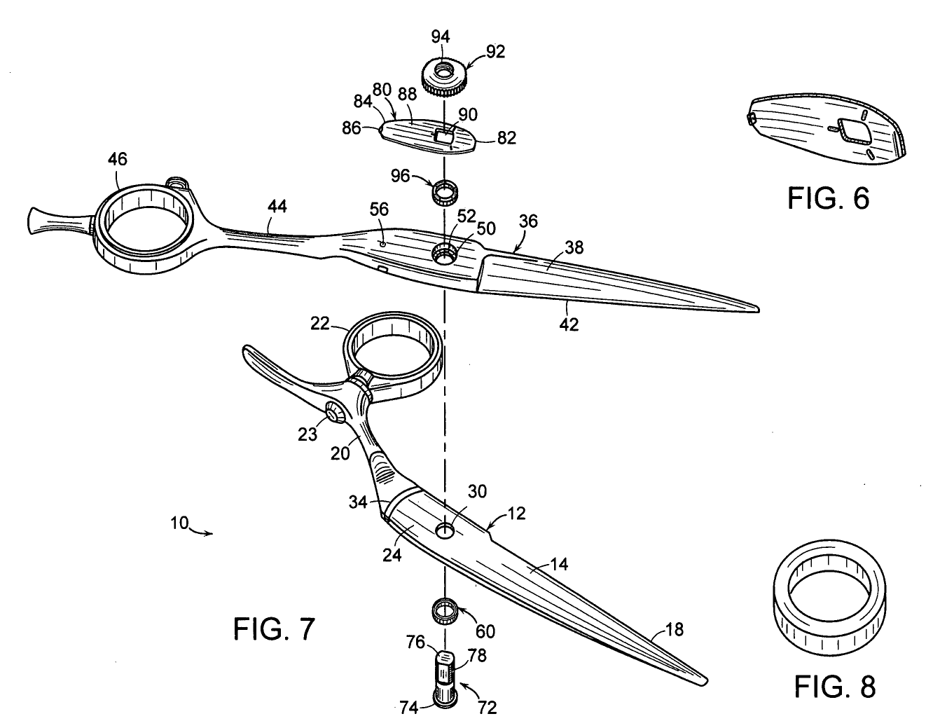

Referring to FIGS. 1-6, the present invention is a device 10 for cutting a person's hair. In one embodiment, the device 10 comprises a first blade member 12 pivotally connected to a second blade member 36. The first blade member 12 comprises an inner surface 14 having a ride-on portion 24 and an outer surface 16 having a recessed portion 26 disposed opposite the ride-on portion 24. The ride-on portion 24 is fabricated to have a planar surface within a precise tolerance. The recessed portion 26 preferably has an annular inner wall 28. The first blade member 12 further comprises a thru-hole 30 extending from the recessed portion 26 to the ride-on portion 24. The first blade member 12 further comprises a cutting edge 18 and a handle portion 20 having a thumb ring 22 adapted to receive the thumb of a person. The thumb ring 22 is connected to the handle portion 20 by a flexible member 23 as known in the art. The first blade member 12 may be made from steel by conventional casting, forging, and/or machining processes.

The second blade member 36 comprises an inner surface 38 having a ride-on portion 48 in direct contact or engagement with the ride-on portion 24 of the first blade member 12. The ride-on portion 48 is fabricated to have a planar surface within a precise tolerance to ensure complete contact of ride-on portions 24 and 48. The second blade member 36 further comprises an outer surface 40 having a having a recessed portion 50 disposed opposite the ride-on portion 48. The recessed portion 50 preferably has an annular inner wall 52. The second blade member 36 further comprises a thru-hole 54 in precise or substantial alignment with the thru-hole 30 of the first blade member 12. The second blade member 36 further comprises a cutting edge 42 and a handle portion 44 having a finger ring 46 adapted to receive a person's finger. The second blade member 36 further comprises a retaining indentation or hole 56 disposed on the outer surface 40 to laterally retain a leaf spring 80 (to be described). The second blade member 36 may be made from steel by conventional casting and machining processes.

The device 10 further comprises first and second ball bearing units 60 and 66 disposed in the recessed portions 26 and 50 of the first and second blade members 12 and 36, respectively. The first and second ball bearing units 60 and 66 comprise inner sleeves 62 and 68 and outer sleeves 64 and 70, respectively. The outer sleeve 64 of the first ball bearing unit 60 is in direct connect or engaged with the annular inner wall 28 of the recessed portion 26 of the first blade member 12. Similarly, the outer sleeve 70 of the second ball bearing unit 66 is in direct contact or engaged with the annular inner wall 52 of the recessed portion 50 of the second blade member 36. Ball bearing units 60 and 66 are available as Item No. MR74 from NSK, Ltd., Nissei Building, 1-6-3, Ohsaki Sinagawa-ku, Tokyo 141-8560, Japan.

The device 10 futher comprises a tension screw 72 passing through the inner sleeves 62 and 68 of the first and second ball bearing units 60 and 66 and the thru-holes 30 and 54 of the first and second blade members 12 and 36. The tension screw 72 comprises a cap portion 74 and an end portion 76 having threads 78. The cap portion 74 is in contact or engaged with the inner sleeve 62 of the ball bearing unit 60 and the end portion 76 extends outward of the thru-hole 54 and the recessed portion 50 of the second blade member 36.

The device 10 further comprises a leaf spring 80 disposed between a tension knob 90 (to be described) and the outer surface 40 of the second blade member 36. The leaf spring 80 comprises end portions 82 and 84 and a median portion 88. End portion 84 is provided with a downwardly extending protrusion 86 which is adapted to be retained in the retaining hole 56 of the second blade member 36. An opening 86 is provided in the median portion 88 to receive the end portion 76 of the tension screw 72.

The device 10 further comprises a tension knob 92 having internal threads 94 adapted to engaged with the threads 78 of the tension screw 72 to maintain direct contact or engagement of the ride-on portion 24 of the first blade member 12 with the ride-on portion 48 of the second blade member 36. The tension knob 92 is selectively engaged with the tension screw 72 to apply a desired pressure to the leaf spring 80 to adjust the engagement or contact pressure of the ride-on portion 24 of the first blade member 12 with the ride-on portion 48 of the second blade member 36.

The device 10 may further comprise glide portions 34 and 58 disposed on one end of the ride-on portions 24 and 48 of the first and second blade members 12 and 36, respectively. The glide portion 34 is in contact or engaged with the glide portion 48 to assist in pivoting of the first and second blade members 12 and 36. The glide-on portions 24 and 48 may be made from a variety of materials such as rylon which is a blend of rayon and nylon and may be molded or otherwise disposed within channels provided in the ride-on portions 24 and 48.

The device 10 may be assembled by placing the first ball bearing unit 60 in the recessed portion 26 of the first blade member 12 and passing the tension screw 72 through the inner sleeve 62 of the ball bearing unit 60 and the thru-hole 32 of the first blade member 12. The second blade member 36 is mounted to the first blade member 12 with the tension screw 72 passing through the thru-hole 54 and ride-on portions 24 and 48 in mating engagement. The second ball bearing unit 66 is placed in the recessed portion 50 of the second blade member 36 with the tension screw 72 passing through and extending outward of the inner sleeve 68 of the second ball bearing unit 66. The leaf spring 80 is mounted to the outer surface 40 of the second blade member 36 with the protrusion 86 of the leaf spring 80 retained within the retaining hole 56 of the second blade member 36 and the end portion 76 of the tension screw 72 passing through and outward of the opening 90 of the leaf spring 80. The tension knob 92 is then selectively engaged with tension screw 72 by engaging the threads 78 with the internal threads 94 to provide tension. Proper tension is achieved when the first and second blade members 12 and 36 remain open. The first and second ball bearing units 60 and 66 provide precise and consistent engagement of the ride-on portions 24 and 48 of the first and second blade members 12 and 36 over an extended period of use.

Referring to FIGS. 7 and 8, in a second embodiment, the device 10 may comprise a steel bushing 96 disposed in the recessed portion 50 rather than the second ball bearing unit 66. Although less desirable, the device 10 has been found to function adequately with only ball bearing unit 60.

The present invention may be embodied in other specific forms without departing from the spirit and/or scope of the specification and appended claims.

What is claimed:

1. A device for cutting hair comprising:
a first blade member comprising an inner surface having a ride-on portion, an outer surface having a recessed portion disposed opposite said ride-on portion, and a thru-hole extending from said recessed portion to said ride-on portion;
a second blade member comprising an inner surface having a ride-on portion in substantial contact with said ride-on portion of said first blade member and an outer surface having a thru-hole substantially aligned with said thru-hole of said first blade member;
a ball bearing unit disposed in said recessed portion of said first blade member; said ball bearing unit comprising an inner sleeve and an outer sleeve engaged with said recessed portion of said first blade member;
a tension screw passing through said inner sleeve of said ball bearing unit and said thru-holes of said-first and second blade members; and
a tension knob engaged with said tension screw to maintain said engagement of said ride-on portion of said first blade member with said ride-on portion of said second blade member.

2. The device of claim 1, wherein said recessed portion comprises an annular inner wall engaged with said outer sleeve of said ball bearing unit.

3. The device of claim 2, wherein said tension screw comprises a cap portion and an end portion; said cap portion is engaged with said inner sleeve of said ball bearing unit and said end portion extends outward of said thru-hole of said second blade member.

4. The device of claim 3, further comprising a leaf spring disposed between said tension knob and said outer surface of said second blade member.

5. The device of claim 4, further comprising first and second glide portions disposed on said ride-on portions of said first and second blade members, respectively; said glide portion of said first blade member being engaged with said glide portion of said second blade member.

6. A device for cutting hair comprising:
a first blade member comprising an inner surface having a ride-on portion, an outer surface having a recessed portion disposed opposite said ride-on portion, and a thru-hole extending from said recessed portion to said ride-on portion;
a second blade member comprising an inner surface having a ride-on portion in substantial engagement with said ride-on portion of said first blade member, an outer surface having a recessed portion disposed opposite said ride-on portion, and a thru-hole substantially aligned with said thru-hole of said first blade member;
first and second ball bearing units disposed in said recessed portions of said first and second blade members, respectively; each of said first and second ball bearing units comprising an inner sleeve and an outer sleeve engaged with said recessed portions of said first and second blade members, respectively;
a tension screw passing through said inner sleeves of said first and second ball bearing units and said thru-holes of said first and second blade members; and
a tension knob engaged with said tension screw to maintain said engagement of said ride-on portion of said first blade member with said ride-on portion of said second blade member.

7. The device of claim 6, wherein said recessed portion of said first blade member comprises an annular inner wall engaged with said outer sleeve of said first ball bearing unit.

8. The device of claim 7, wherein said recessed portion of said second blade member comprises an annular inner wall engaged with said outer sleeve of said second ball bearing unit.

9. The device of claim 8, wherein said tension screw comprises a cap portion and an end portion; said cap portion is engaged with said inner sleeve of said first ball bearing unit and said end portion extends outward of said thru-hole of said second blade member.

10. The device of claim 9, further comprising a leaf spring disposed between said tension knob and said outer surface of said second blade member.

11. The device of claim 10, further comprising first and second glide portions disposed on said ride-on portions of said first and second blade members, respectively; said glide portion of said first blade member being engaged with said glide portion of said second blade member.
